(19) United States
(12) Patent Application Publication
(10) Pub. No.: US 2010/0190524 A1
(43) Pub. Date: Jul. 29, 2010

(54) PORTABLE ELECTRONIC DEVICE

(76) Inventor: Takahiko Morozumi, Kumagaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/603,330

(22) Filed: Oct. 21, 2009

(30) Foreign Application Priority Data
Jan. 26, 2009 (JP) 2009-014652

(51) Int. Cl. H04M 1/00

(52) U.S. Cl. 455/556.1

(57) ABSTRACT

According to one embodiment, a portable electronic device includes a first unit configured to be placed on a mounting surface, a second unit swingably connected to the first unit, a projector module in the second unit, and a tilt sensor in the second unit, the tilt sensor being configured to detect a tilt angle of the second unit. The projector module includes an image processing section configured to correct a keystone distortion of a projected image based on the tilt angle of the second unit detected by the tilt sensor.

### CROSS-REFERENCE TO RELATED APPLICATIONS

This application is based upon and claims the benefit of priority from Japanese Patent Application No. 2009-014652, filed Jan. 26, 2009, the entire contents of which are incorporated herein by reference.

### BACKGROUND

1. Field

One embodiment of the invention relates to a portable electronic device with projector function.

2. Description of the Related Art

Portable electronic devices with projector function have been provided in recent years. Jpn. Pat. Appln. KOKAI Publication No. 2004-289401 discloses a cellular phone provided with an image projection unit in its display section. This cellular phone projects an incoming notification image indicative of the incoming of information onto a projection screen that is visible to a user when the information is received through a communication network.

Jpn. Pat. Appln. KOKAI Publication No. 2008-158093 discloses a cellular phone provided with a projector in its display section. In this cellular phone, a projection lens of the projector is also used as an imaging lens of a camera section.

If the projector is provided in the display section of the cellular phone, for example, an image on a projection screen is inevitably distorted into a trapezoidal shape, depending on the attitude of the display section. Since the distorted image is hard to observe, the user cannot obtain high convenience.

Portable electronic devices, such as cellular phones, are expected to be smaller and lighter in weight. Therefore, it is desirable that the portable electronic devices have the simplest possible structure with fewer mounted components.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of a cellular phone according to a first embodiment of the invention;

FIG. 2 is an exemplary side view of the cellular phone according to the first embodiment;

FIG. 3 is an exemplary system configuration diagram of the cellular phone according to the first embodiment;

FIG. 4 is an exemplary view showing keystone correction of the cellular phone according to the first embodiment;

FIG. 5 is an exemplary side view of a cellular phone according to a second embodiment of the invention;

FIG. 6 is an exemplary system configuration diagram of the cellular phone according to the second embodiment;

FIG. 7 is an exemplary plan view of a main section of the cellular phone according to the second embodiment;

FIG. 8 is an exemplary view showing keystone correction of the cellular phone according to the second embodiment; and

FIG. 9 is an exemplary side view of a cellular phone according to a third embodiment of the invention.

### DETAILED DESCRIPTION

Various embodiments according to the invention will be described hereinafter with reference to the accompanying drawings. In general, according to one embodiment of the invention, a portable electronic device comprises a first unit configured to be placed on a mounting surface, a second unit swingably connected to the first unit, a projector module in the second unit, and a tilt sensor in the second unit, the tilt sensor being configured to detect a tilt angle of the second unit. The projector module comprises an image processing section configured to correct a keystone distortion of a projected image based on the tilt angle of the second unit detected by the tilt sensor.

Embodiments of the present invention that are applied to a cellular phone with projector function will now be described with reference to the accompanying drawings.

### First Embodiment

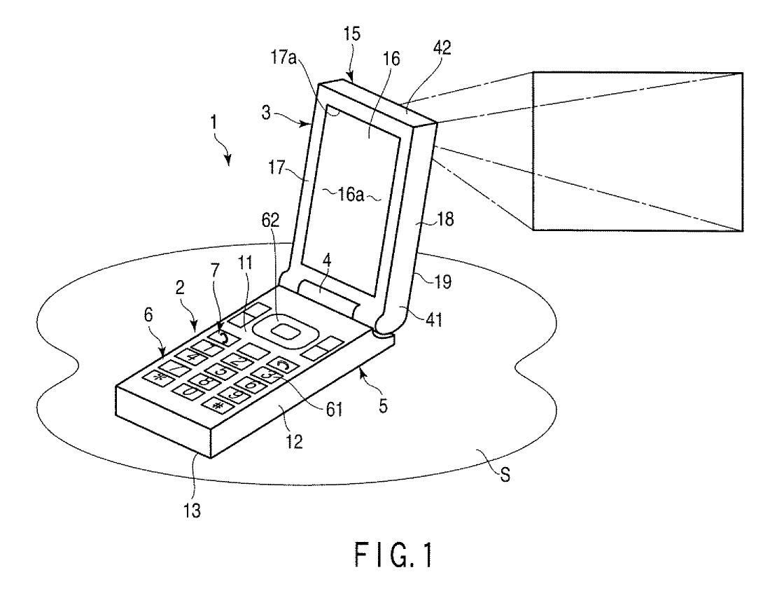

FIGS. 1 to 4 show a cellular phone 1 as a portable electronic device according to a first embodiment of the invention. As shown in FIG. 1, the cellular phone 1 comprises a main section (main unit) 2, display section (display unit) 3, and hinge section 4. The main section 2 is an example of a first unit according to the invention. The display section 3 is an example of a second unit according to the invention.

The hinge section 4 is provided between the main section 2 and display section 3 and connects the display section 3 to the main section 2 for rocking motion. In other words, the display section 3 is swingably connected to the main section 2 by the hinge section 4. The cellular phone 1 is swingable between a first position in which it is doubled so that the display section 3 overlies the main section 2 and a second position in which the display section 3 is unfolded from the main section 2.

As shown in FIG. 1, the cellular phone 1 comprises a housing 5. The housing 5 comprises a first part 6 that forms an outer wall of the main section 2 and a second part 15 that forms an outer wall of the display section 3. Specifically, the housing 5 comprises the first and second parts 6 and 15 swingably connected to each other by the hinge section 4 and can be doubled.

As shown in FIG. 1, the main section 2 is a part configured to be placed on a mounting surface S (e.g., desktop). The main section 2 is provided with the first part 6 of the housing 5 and a key input section 7. The first part 6 of the housing 5 is in the form of, for example, a flat, substantially cuboid box.

The first part 6 of the housing 5 is provided with an upper surface portion 11, peripheral surface portion 12, and bottom (i.e., lower) surface portion 13. The bottom surface portion 13 comprises a surface that is opposed to the mounting surface S when the cellular phone 1 is placed on the surface S. The bottom surface portion 13 spreads so that it can be substantially parallel to the mounting surface S. The upper surface portion 11 spreads substantially parallel to the bottom surface portion 13 with a space between them. The peripheral surface portion 12 stands with respect to the bottom surface portion 13 and connects the respective peripheral edge portions of the bottom and upper surface portions 13 and 11.

The key input section 7 is provided on the upper surface portion 11 of the first part 6 of the housing 5. Thus, the key input section 7 is exposed on the upper surface of the cellular phone 1 in a state where the cellular phone 1 is placed on the mounting surface S. A user can operate the key input section 7 with the cellular phone 1 on the mounting surface S.

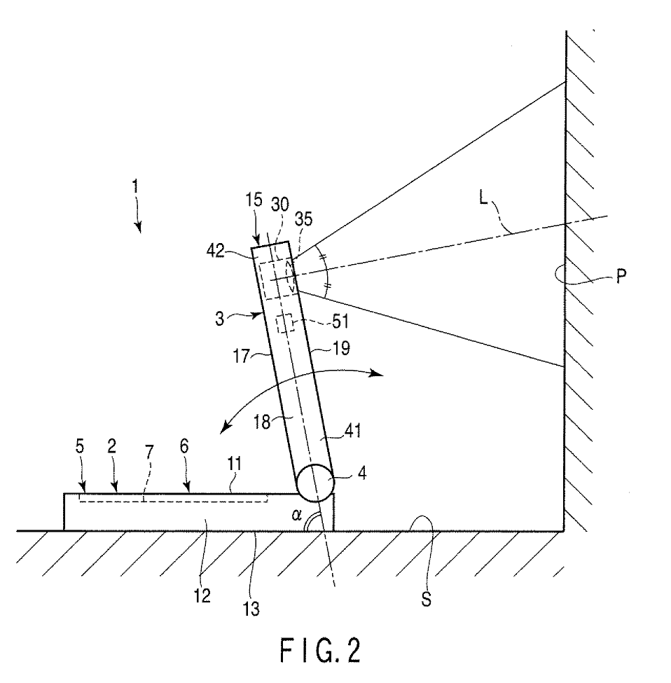

As shown in FIGS. 1 and 2, the display section 3 is provided with the second part 15 of the housing 5 and a display device 16. The second part 15 of the housing 5 is in the form of, for example, a flat, substantially cuboid box.

The second part 15 of the housing 5 is provided with a front surface portion 17, peripheral surface portion 18, and rear surface portion 19. The front surface portion 17 comprises a surface that is opposed to the upper surface portion 11 of the first part 6 of the housing 5 when the cellular phone 1 is folded. The rear surface portion 19 spreads substantially parallel to the front surface portion 17. The peripheral surface portion 18 stands with respect to the front surface portion 17 and connects the respective peripheral edge portions of the front and rear surface portions 17 and 19.

The display device 16 is mounted in the display section 3 and contained in the second part 15 of the housing 5. The display device 16 comprises a display screen 16a. The front surface portion 17 of the second part 15 of the housing 5 has an opening 17a through which the display screen 16a is exposed to the outside of the second part 15.

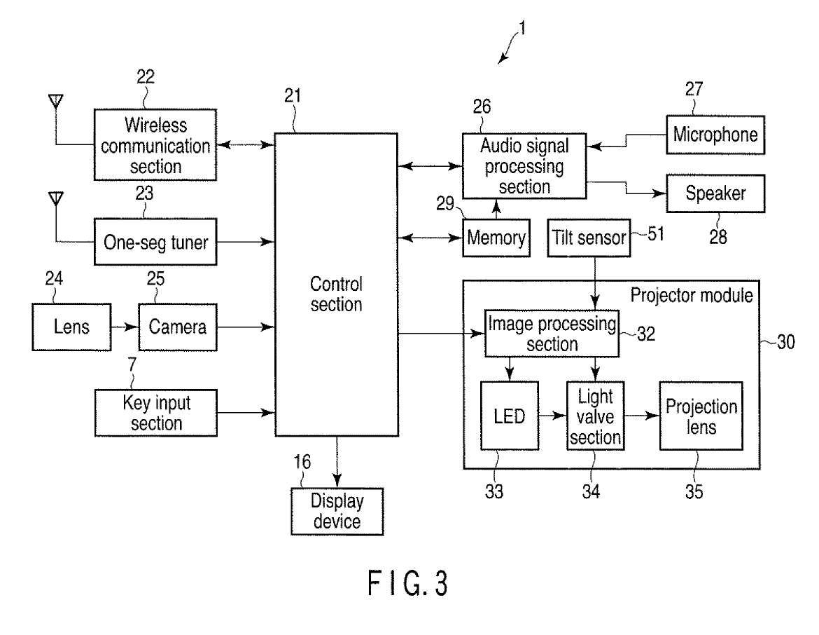

As shown in FIG. 3, the cellular phone 1 is provided with a control section 21, wireless communication section 22, one-segment broadcasting tuner 23, lens 24, camera 25, aforementioned key input section 7, audio signal processing section 26, microphone 27, speaker 28, memory 29, aforementioned display device 16, and projector module 30. In FIG. 3, arrows indicate signal flows.

Since the control section 21, wireless communication section 22, one-segment broadcasting tuner 23, lens 24, camera 25, key input section 7, audio signal processing section 26, microphone 27, speaker 28, memory 29, and display device 16 have the same functions and configurations as those of their counterparts in conventional cellular phones, a detailed description thereof is omitted. The following is a detailed description of the projector module 30.

As shown in FIG. 2, the projector module 30 is mounted in the display section 3. The projector module 30 is contained in, for example, the second part 15 of the housing 5. As shown in FIG. 3, the projector module 30 comprises an image processing section 32, LED section 33, light valve section 34, and projection lens 35.

The control section 21 controls the operation of the projector module 30 based on signals input from various parts of the cellular phone 1. The control section 21 sends data on an image projected by the projector module 30 to the image processing section 32.

Based on the image data received from the control section 21, the image processing section 32 creates a driving signal for driving the LED section 33 and light valve section 34. The LED section 33 is a light source comprising three LEDs corresponding to, e.g., RGB. The LED section 33 radiates light based on the driving signal received from the image processing section 32.

The light valve section 34 modulates the light from the LED section 33. The projection lens 35 is opposed to an opening (not shown) in the rear surface portion 19 of the second part 15 of the housing 5. As shown in FIG. 2, the light modulated by the light valve section 34 is enlarged by the projection lens 35 and projected on a projection screen P. Although the projector module 30 used in the present embodiment is of the light-valve type, it may be replaced with a projector module of another type.

As shown in FIG. 2, the second part 15 of the housing 5 comprises a first end portion 41 connected to the hinge section 4 and a second end portion 42 located opposite from the first end portion 41. The projector module 30 is disposed in, for example, the second end portion 42 of the second part 15 of the housing 5. The second end portion 42 is kept relatively wide apart from the mounting surface S when the display section 3 is raised from the main section 2.

As shown in FIG. 2, an optical axis L of the projection lens 35 is oriented at right angles to the rear surface portion 19 of the second part 15 of the housing 5. The projector module 30 projects the image through the central part of the projection lens 35.

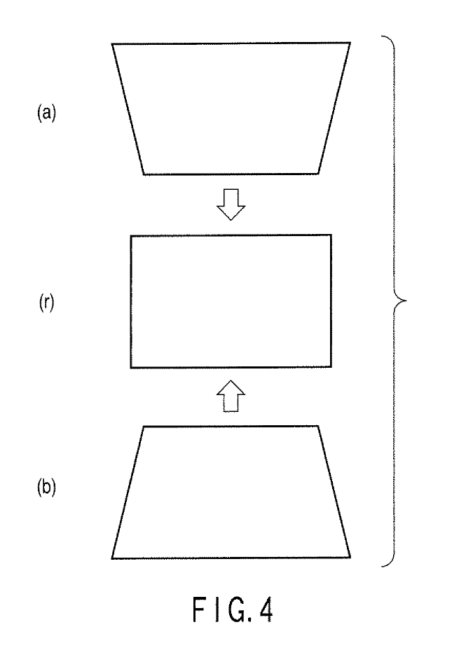

As shown in FIG. 2, the direction of projection of the image by the projector module 30 can be freely changed by swinging the display section 3 relative to the main section 2. If the image is then projected upward onto the projection screen P from below, as shown in FIG. 2, it is distorted into the shape of a trapezoid having an upper side longer than its lower side, as indicated by (a) in FIG. 4. Thus, the image undergoes a so-called keystone distortion. Likewise, if the image is projected downward onto the projection screen P from above, it undergoes a keystone distortion such that its upper side is shorter than its lower side, as indicated by (b) in FIG. 4.

In the present embodiment, as shown in FIG. 2, a tilt sensor (i.e., angle sensor) 51 is mounted in the display section 3 (i.e., that unit of the folding portable electronic device which is provided with the projection lens 35). The tilt sensor 51 is, for example, an acceleration sensor, which detects a tilt angle α of the display section 3 with respect to the mounting surface S. As shown in FIG. 3, the tilt sensor 51 sends a detection result on the tilt angle α of the display section 3 to the image processing section 32.

The image processing section 32 according to the present embodiment corrects the keystone distortion (i.e., performs the so-called keystone correction) of the projected image based on the tilt angle α of the display section 3 detected by the tilt sensor 51. More specifically, the image processing section 32 creates a image signal reversely distorted in advance so as to cancel the keystone distortion, and drives the LED section 33 and light valve section 34 based on the created signal. Thus, a rectangular image without distortion is formed on the projection screen P, as indicated by (r) in FIG. 4.

If the tilt angle α of the display section 3 to the mounting surface S varies, the extent of the keystone distortion varies. The image processing section 32 changes the amount of keystone correction in accordance with the tilt angle α of the display section 3, and performs the keystone correction so that the constant image can be projected without regard to the tilt angle α of the display section 3.

The following is a description of the operation of the cellular phone 1 according to the present embodiment.

The cellular phone 1 is provided with the projector module 30 in the display section 3 that is swingably connected to the main section 2. Thus, the user can easily adjust the projection angle of the image by adjusting the tilt angle α of the display section 3 to the main section 2, so that the image can be projected at an arbitrary height.

The control section 21 allocates input functions related to various adjustments of the image, such as image selection, color change, etc., to individual keys of the key input section 7 during execution of, for example, a projector function. The user can perform key input while the projector function is being executed, and carry out operations for the various adjustments of the image (e.g., image selection, color change, etc.) without changing the position of projection of the image.

In the cellular phone 1 according to the present embodiment, the tilt sensor 51 mounted in the display section 3 detects the tilt angle α of the display section 3. The projector module 30 projects the image, which is subjected to the keystone correction in accordance with the tilt angle α of the display section 3, onto the projection screen P. Thus, an image with only a small distortion can be projected on the projection screen P.

If the user changes the tilt angle of the display section 3 in order to adjust the projection angle of the image, the projector module 30 subjects the image to keystone correction following the change. Thus, the constant image can be projected on the projection screen P even though the user changes the tilt angle of the display section 3 in order to adjust the projection angle of the image.

According to this arrangement, there is provided a portable electronic device with projector function that is simple in construction and suffers only a small image distortion. Thus, the cellular phone 1 performs the keystone correction based on the tilt angle α of the display section 3, as described above, so that it can project an image with only a small distortion. The tilt angle α of the display section 3 on which the amount of keystone correction depends is detected by the tilt sensor 51 in the display section 3. According to this arrangement, there provided the cellular phone 1 in which the tilt angle α of the display section 3 can be detected with a substantially minimum necessary configuration and the keystone correction can be properly performed with a simple configuration.

### Second Embodiment

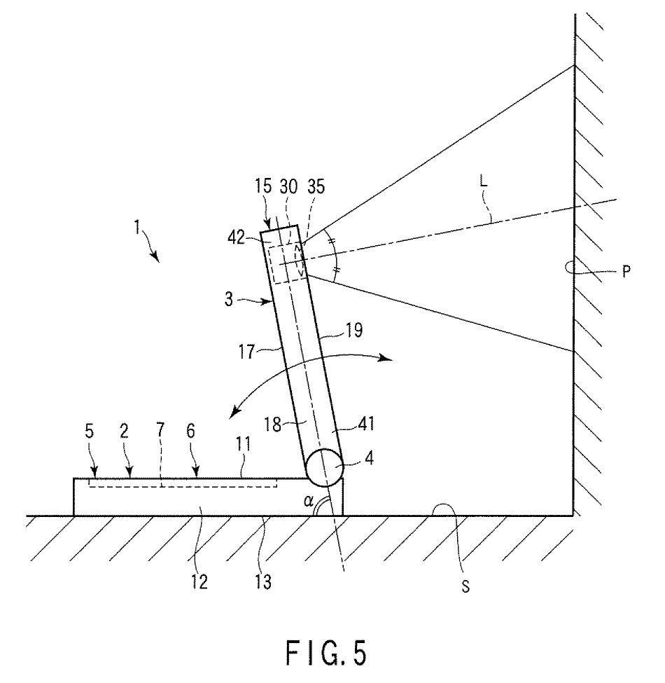

A cellular phone 1 as a portable electronic device according to a second embodiment of the invention will now be described with reference to FIGS. 5 to 8. Like numbers are used to designate configurations with functions that are the same as or similar to those of the first embodiment, and a description of those configurations is omitted. Other configurations than those described below are shared with the first embodiment.

As shown in FIG. 5, a main section 2 is provided with a first part 6 of a housing 5 and a key input section 7. The key input section 7 is provided on an upper surface portion 11 of the first part 6 of the housing S. The key input section 7 can also be operated while a projector module 30 is projecting an image with a display section 3 unfolded from the main section 2. The display section 3 is provided with a second part 15 of the housing 5 and a display device 16. The projector module 30 is mounted in the display section 3.

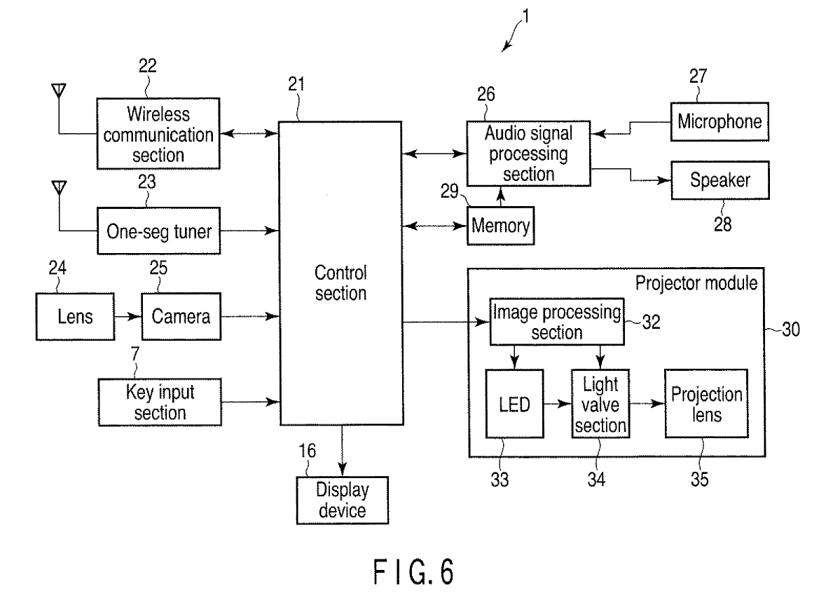

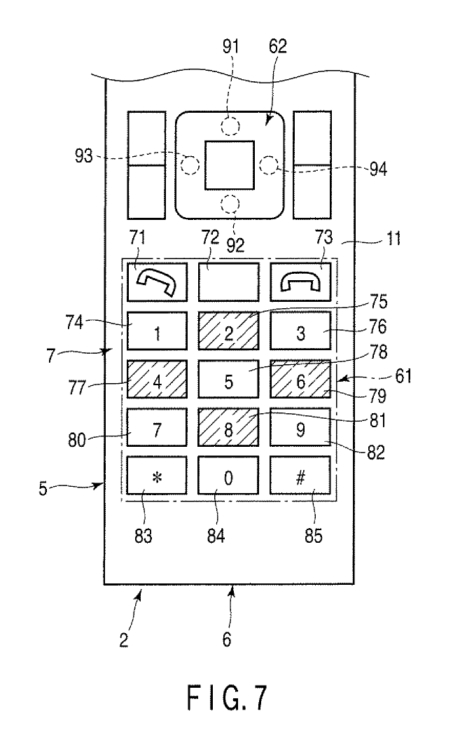

As shown in FIGS. 5 and 6, the cellular phone 1 according to the present embodiment does not comprise the tilt sensor 51. An image processing section 32 corrects a keystone distortion of the projected image based on an input from the key input section 7. More specifically, the key input section 7 comprises a numeric keypad 61 and control key 62 for screen control, as shown in FIG. 7. The numeric keypad 61 is based on a key group for inputting numbers and characters and comprises keys (i.e., dial keys) 71 to 85 corresponding individual to numbers 0 to 9 and the like.

As shown in FIG. 7, the keys 71 to 85 are arranged like a lattice around the key 78 corresponding to, for example, the number 5. The key 78 corresponding to the number 5 is an example of a first key according to the invention.

The keys 75 and 81 corresponding to the numbers 2 and 8, respectively, are located individually above and below the key 78 corresponding to the number 5, when viewed vertically from above the main section 2. The key 75 corresponding to the number 2 is an example of a second key according to the invention, which is located above (i.e., on the far side of) the key 78. The key 81 corresponding to the number 8 is an example of a third key according to the invention, which is located below (i.e., on the near side of) the key 78.

The keys 77 and 79 corresponding to the numbers 4 and 6, respectively, are located individually on the left and right of the key 78 corresponding to the number 5, when viewed vertically from above the main section 2. The key 77 corresponding to the number 4 is an example of a fourth key according to the invention, which is located on the left of the key 78. The key 79 corresponding to the number 6 is an example of a fifth key according to the invention, which is located on the right of the key 78.

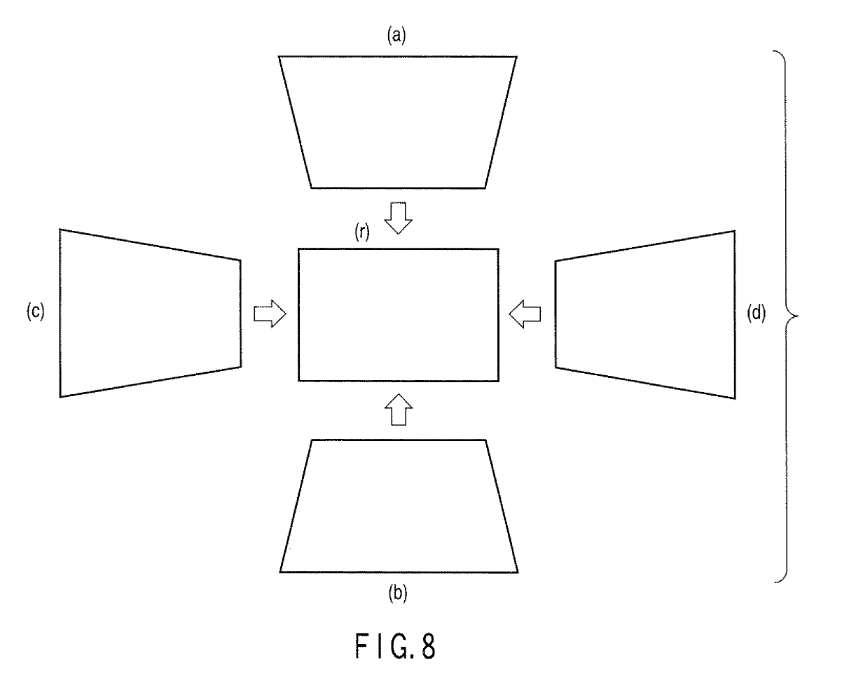

If the image is projected obliquely onto the projection screen P from below or above, as shown in FIG. 8, a vertical keystone distortion occurs. According to the present invention, the vertical keystone distortion is a distortion of the image such that its upper and lower sides have different lengths, as indicated by (a) or (b) in FIG. 8. Likewise, if the image is projected obliquely onto the projection screen P from left or right, a horizontal keystone distortion occurs. According to the present invention, the horizontal keystone distortion is a distortion of the image such that its left and right sides have different lengths, as indicated by (c) or (d) in FIG. 8.

The control section 21 allocates input functions for keystone correction to the keys of the numeric keypad 61 when the projector module 30 is operating. More specifically, the control section 21 allocates keystone correction input functions for correcting the vertical keystone distortion to the keys 75 and 81 corresponding to the numbers 2 and 8, respectively, which are arranged vertically with the key 78 corresponding to the number 5 between them. Further, the control section 21 allocates keystone correction input functions for correcting the horizontal keystone distortion to the keys 77 and 79 corresponding to the numbers 4 and 6, respectively, which are arranged horizontally with the key 78 between them.

The control section 21 sends an input content accepted as a keystone correction input operation to the image processing section 32 of the projector module 30. The image processing section 32 corrects a keystone distortion based on an input from the numeric keypad 61. More specifically, the image processing section 32 corrects the vertical keystone distortion of the image when the key 75 or 81 corresponding to the number 2 or 8 is operated. Further, the image processing section 32 corrects the horizontal keystone distortion of the image when the key 77 or 79 corresponding to the number 4 or 6 is operated. The image processing section 32 can change the amount of keystone correction based on the frequency or duration of depression of, for example, each of the keys 75, 77, 79 and 81.

The image processing section 32 may be configured to correct the keystone distortion based on an input from, for example, the control key 62 for screen control in place of the numeric keypad 61. The control key 62 is used to select an item displayed on, for example, the display screen 16a when the projector function is disabled. The control key 62 comprises a first input part 91 corresponding to, e.g., “up”, second input part 92 corresponding to “down”, third input part 93 corresponding to “left”, and fourth input part 94 corresponding to “right”. The first and second input parts 91 and 92 are arranged vertically (i.e., up and down). The third and fourth input parts 93 and 94 are arranged horizontally (i.e., left and right).

The image processing section 32 may be configured to correct the vertical keystone distortion of the image when the first input part 91 or the second input part 92 is operated, for example. The image processing section 32 may be configured to correct the horizontal keystone distortion of the image when the third input part 93 or the fourth input part 94 is operated, for example. The key for the keystone correction input may be any other key than the numeric keypad 61 or control key 62.

The following is a description of the operation of the cellular phone 1 according to the present embodiment.

In operating the cellular phone 1 according to the present embodiment, the user employs the key input section 7 to input the direction and amount of correction of the keystone distortion. The projector module 30 projects the image, which is subjected to the keystone correction based on information input by the user, onto the projection screen P.

According to this arrangement, there is provided a portable electronic device with projector function that is simple in construction and suffers only a small image distortion. Thus, the cellular phone 1 performs the keystone correction in the same manner as in the first embodiment, so that it can project an image with only a small distortion. Since the user uses the key input section 7 to input the keystone distortion correction, moreover, there is provided the cellular phone 1 that can properly perform the keystone correction with a simple configuration without requiring the tilt sensor 51 or the like.

A special input key for keystone correction need not be provided if the input functions for keystone correction are allocated to keys that are originally designed for other purposes, such as the keys of the numeric keypad 61 and control key 62 for screen control of the cellular phone 1. Thus, the configuration of the cellular phone 1 can be further simplified.

The numeric keypad 61, comprising the specific central key 78 and the keys 75, 77, 79 and 81 that are arranged vertically and horizontally around the key 78, can perform vertical and horizontal keystone corrections. If so, the correlation between the user's request and an actually needed operation can be easily imaged to ensure high convenience, since the direction of the keystone distortion correction is coincident with that of key location.

### Third Embodiment

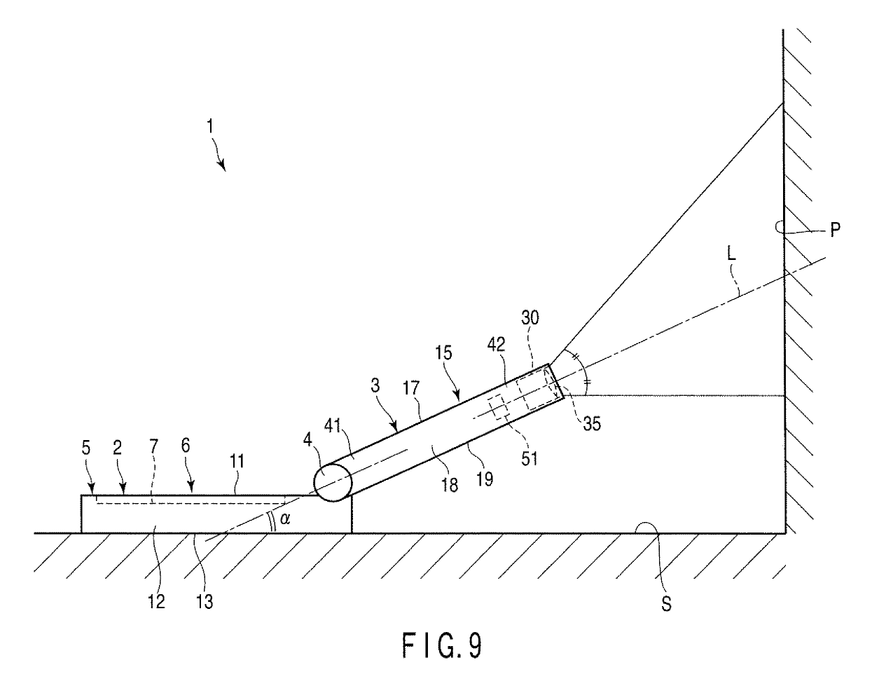

A cellular phone 1 as a portable electronic device according to a third embodiment of the invention will now be described with reference to FIG. 9. Like numbers are used to designate configurations with functions that are the same as or similar to those of the first and second embodiments, and a description of those configurations is omitted. As shown in FIG. 8, the present embodiment differs from the first embodiment only in the mounting position and orientation of the projector module 30, and other configurations are the same as those of the first embodiment.

As shown in FIG. 9, the projector module 30 is located at a second end portion 42 of a second part 15 of a housing 5. A projection lens 35 is opposed to an opening (not shown) in a peripheral surface portion 18 of the second end portion 42 (i.e., upper surface portion of the second part 15 of the housing 5). An optical axis L of the projection lens 35 extends along the length direction of the second part 15 of the housing 5.

According to this arrangement, as in the first embodiment, there is provided a portable electronic device with projector function that is simple in construction and suffers only a small image distortion. The cellular phone 1 according to the present embodiment may be configured so that the keystone distortion is corrected based on an input from a key input section 7 in place of the result of detection by a tilt sensor 51, as in the second embodiment.

Although the cellular phones 1 according to the first to third embodiments of the invention have been described herein, the invention is not limited to these embodiments. In carrying out the invention, the components of the embodiments can be combined as required. Specifically, the keystone correction may be performed based on both the result of detection by the tilt sensor 51 mounted in the display section 3 and the input through the key input section 7.

The first unit according to the present invention is not limited to the main section 2, and neither is the second unit to the display section 3. In a portable electronic device configured so that the display section 3 is laid on the mounting surface S with the main section 2 raised when the projector function is used, for example, the display section 3 and main section 2 correspond to the first and second units, respectively.

In the portable electronic devices of the first to third embodiments described above, the projector module 30 is incorporated in the second part 15 of the housing 5. However, the present invention is not limited to this arrangement, and the projector module 30 may alternatively be externally mounted on the second part 15 (or first part 6) of the housing 5.

Although the input functions for keystone correction are allocated to the keys 75, 77, 79 and 81 around the key 78 corresponding to the number 5 in the second embodiment, they may alternatively be allocated to keys around another core key. The portable electronic device to which the present invention is applicable is not limited to a cellular phone, and is also applicable to a projector that is not provided with the display device 16.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A portable electronic device comprising:
a first unit configured to be placed on a mounting surface;
a second unit swingably connected to the first unit;
a projector module in the second unit; and
a tilt sensor in the second unit, the tilt sensor being configured to detect a tilt angle of the second unit,
the projector module comprising an image processing section configured to correct a keystone distortion of a projected image based on the tilt angle of the second unit detected by the tilt sensor.

2. A portable electronic device comprising:
a first unit configured to be placed on a mounting surface;
a second unit swingably connected to the first unit;
a key input section provided on the first unit; and
a projector module in the second unit,
the projector module comprising an image processing section configured to correct a keystone distortion of a projected image based on an input from the key input section.

3. A portable electronic device of claim 2, wherein the key input section is provided with at least one of a numeric keypad and a control key for screen control, and the image processing section is configured to correct the keystone distortion based on an input from the numeric keypad or the control key.

4. A portable electronic device of claim 3, wherein the numeric keypad comprises a first key, a second key and a third key located above and below the first key, respectively, when viewed vertically from above, and a fourth key and a fifth key located on the left and right of the first key, respectively, when viewed vertically from above, and the image processing section is configured to correct a vertical keystone distortion of the image when the second key or the third key is operated and to correct a horizontal keystone distortion of the image when the fourth key or the fifth key is operated.
